(19) United States
(12) Patent Application Publication
(10) Pub. No.: US 2005/0129234 A1
(43) Pub. Date: Jun. 16, 2005

(54) Method to update access right to conditional access data

(76) Inventor: Gregory Duval, La Conversion (CH)

Correspondence Address: HARNESS, DICKEY & PIERCE, P.L.C., P.O. BOX 8910, RESTON, VA, 20195, US

(21) Appl. No.: 11/012,230

(22) Filed: Dec. 16, 2004

(30) Foreign Application Priority Data
Dec. 16, 2003 (EP) 03104710.3

(51) Int. Cl. H04N 7/167

(52) U.S. Cl. 380/239

(57) ABSTRACT

A method is proposed to update access rights to conditional access data. In this method, the group number in which the access rights must be updated is first determined, and then all the security modules connected to this group are determined. Subsequently, according to the embodiment chosen, either an encrypting key for each of the modules with the access rights that must be updated is determined, or a subscriber key (K_{AB}) common to all the security modules of a determined group with rights to be updated is determined. The rights are then encrypted with the corresponding key. The authorization messages (EMM) containing said encrypted access rights and an identifier of the security modules for which they are destined are sent. These rights are then received and decrypted in the security modules corresponding to said identifiers.

The present application hereby claims priority under 35 U.S.C. §119 on European patent application number EP 03104710.3 filed Dec. 16, 2003, the entire contents of which are hereby incorporated herein by reference.

This invention relates to a method to update access rights to conditional access data, in particular in a Pay-TV system when a subscriber has several decoders.

At present, in order to be able to access encrypted contents relating to events diffused by Pay-TV operators, such as films, sports matches or the like, it is necessary to acquire a subscription, a decoder and a security module. Some subscribers wish to dispose of several decoders and several security modules so that several users can access events diffused from several televisions positioned in different places in their home.

In this case, when an access right to encrypted contents must be loaded into a security module of a subscriber, a management centre sends an authorization message which contains an identification number relating to one or more determined security modules. This message also contains the access right to be loaded.

The authorization messages can be formatted in three different ways. According to a first method, the authorization messages include a unique identification number that only allows one security module to receive and decipher the contents of the message. According to a second method, the authorization message contains an identifier taken in a determined range of identifiers, this range relating to an assembly of security modules. This type of unit can, for example, contain 256 security modules. The message can be received and deciphered by all the modules of this unit. According to a third method, the authorization messages are sent in a global way to all the security modules of a determined operator.

A problem arises for the management of the rights of subscribers possessing several decoders. In fact, at present, each decoder is considered as independent. When a subscriber having several decoders acquires a right, the management centre must send a management message to each of these decoders. Therefore, it is possible that the rights are not loaded in an identical way in each of the security modules associated to decoders of this subscriber.

This invention intends to avoid the drawbacks of updating processes of access rights in the prior art by providing a process that guarantees that the rights of a determined subscriber with several decoders are loaded in an identical way into all the decoders of this subscriber.

This aim is achieved by a method to update rights to conditional access data as defined in the preamble, used in particular in a Pay-TV system including a management centre for access rights, this management centre transmitting these rights to decoders associated to security modules, characterized in that it comprises the steps of determination of a group number in which access rights must be updated; determination of all security modules connected to this group number; determination of the encrypting keys of said security modules; encryption of the access rights with said encrypting keys; sending of authorization messages (EMM) containing said encrypted access rights and an identifier of the security modules for which they are intended and for the reception and decrypting of the access rights in the security modules corresponding to said identifiers.

The aim of the invention is also achieved by a method to update rights to conditional access data, in particular in a Pay-TV system including a management centre of the access rights, this management centre transmitting these rights to decoders associated to security modules, characterized in that it includes the steps of determination of a group number in which the access rights must be updated; determination of all the security modules connected to this group number; determination of a subscription key (K_{AB}) common to all the security modules connected to said group number; encryption of the access rights with said subscription key; sending of an authorization message EMM containing said encrypting rights and an identifier of the security modules for which they are destined and for the reception and decryption of the access rights in the security modules corresponding to said identifier.

This invention ensures the uniformity of the rights for each decoder of a subscriber, so that the rights corresponding to this subscriber from one of his decoders will also be available from one of his other decoders. The management of the subscribers is also simpler from the point of the view of the management centre, since the decoders of the subscribers are managed globally and not individually.

In certain embodiments, the invention also allows the reduction, in a sensitive way, of the number of authorization messages that must be transmitted to subscribers that releases the bandwidth for other applications.

This present invention and its advantages will be better understood thanks to the following detailed description that refers to the enclosed drawings given as non-limitative examples, in which:

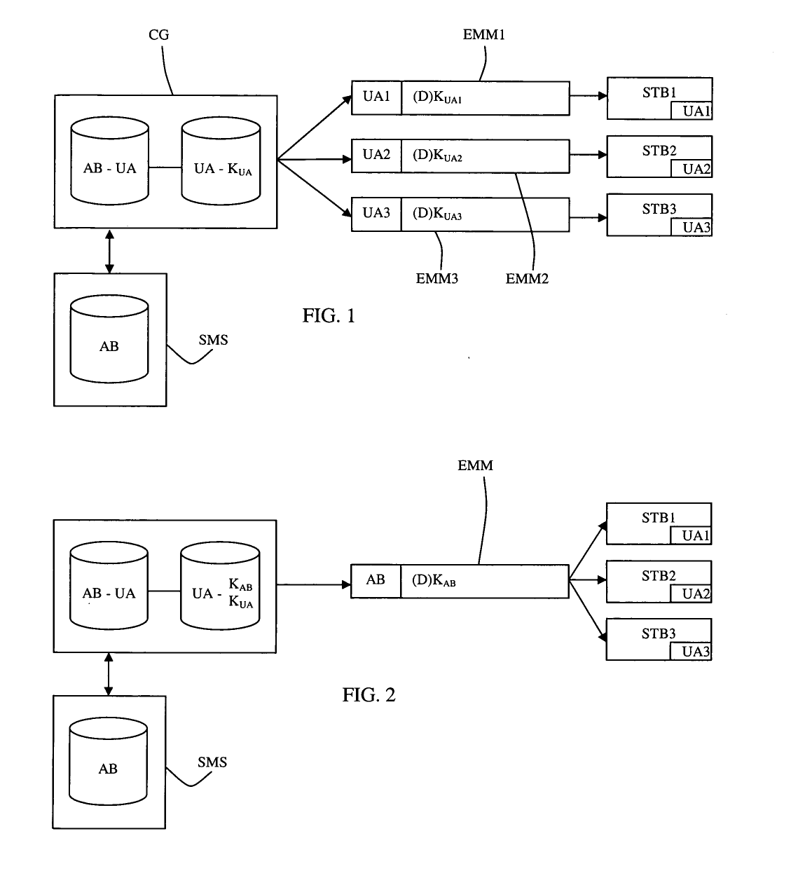

FIG. 1 shows schematically, a first embodiment of the process of this present invention; and

FIG. 2 shows a second embodiment of the process of this invention.

Using a well-known method, the access control to data, for example, in the domain of Pay-TV, is carried out from a management centre CG that sends messages, in particular authorization messages EMM, to decoders placed in a subscriber's home. Each decoder cooperates with a security module in charge of the control operations of the rights. In particular, the security modules contain an encrypting key K_{UA} that is also stored in the management centre in such a way as to allow the exchange of security data between the management centre and the security module of a decoder.

It should be noted that in general, the process according to the invention is intended for individuals with a subscription, for example, of the monthly type or of an indeterminate duration. However, this process can also apply to individuals possessing several decoders, but who are not necessarily subscribed to an operator. These individuals can acquire rights in the form of impulsive purchases or by means of pre-payment. In this case, the decoders of these individuals must be indexed if the situation is to be avoided in which the rights are acquired from one of the decoders and are then available from other decoders that do not belong to the same person. Hereinafter, a subscriber is understood to mean all individuals having access to conditional access data when the rights are acquired by a valid subscription for a certain time or a certain amount, by means of an impulse purchase, by prepayment or by any other form of acquiring rights. The decoders belonging to a subscriber form part of a group and will be referred to regardless of the group number or subscription number.

With reference to the Figures, the process according to the invention is implemented from a management centre CG that contains, in a conventional way, a list of the unique identification numbers UA of each security module associated to decoders belonging to subscribers with rights managed by this centre. The management centre contains also the encrypting key K_{UA} associated to each identification number.

In the process according to the invention, each subscriber disposes of a unique subscription number AB. The management of these subscription numbers, as well as other administrative aspects, is processed in a subscriber processing system SMS, that communicates with the management centre. This management centre CG includes a database containing on one hand, the subscriber number AB of each subscriber whose rights are managed by the management centre, and on the other hand, the unique identification numbers UA of the security modules of the subscribers. This database allows a determined subscriber number AB to determine the identification numbers UA of the security modules of which it disposes.

In a first embodiment, represented by FIG. 1, when an authorization message EMM must be transmitted to a subscriber, first it is determined which are the unique identification numbers UA related to the subscriber number AB to which the message must be transmitted. There are unique numbers for each decoder of the subscriber. When these identification numbers UA are known, the subsequent stage of the process according to the invention consists in generating authorization messages EMM for the security modules, and thus for decoders, connected to this subscription. As is well known, the authorization messages contain in particular an identifier in plaintext, which allows the decoders to determine if the messages that they receive are intended for the security modules to which they are connected. The authorization messages also contain the rights that are encrypted so that they can only be used by the decoder for which they are intended. In the embodiment example disclosed in FIG. 1, a subscriber has three decoders and therefore three security modules. The management centre thus generates three authorization messages, EMM1, EMM2, EMM3. Each of these messages contains an identifier UA1, UA2, UA3 that allow the decoders to determine if these messages are intended for them. They also contain the rights, encrypted by the encrypting key KU_{A1}, KU_{A2}, KU_{A3} contained in the management centre and in the security module with the corresponding identifier UA1, UA2, UA3.

When the authorization messages are generated for a determined subscription number AB belonging to a subscriber having several decoders, the content in plaintext must correspond to identical rights for each decoder. As the rights are encrypted with a different key for each decoder, the encrypted content is different. The decryption of the rights is carried out in a conventional way, using the key K_{UA} stored in the security module associated to the decoder that has received the message.

In a second embodiment of the invention schematically illustrated in FIG. 2, the management centre only generates one authorization message EMM for all the decoders connected to a determined subscription number. For this, the management centre contains as previously, a list of the subscription numbers AB associated to unique identification numbers UA of the security modules belonging to each subscriber. Furthermore, the management centre contains, for each unique identification number UA, two encrypting keys. The first key K_{UA} is the same as that used in the previous embodiment and corresponds to the unique key of a security module. The second key K_{AB} is a subscription key common to all the security modules belonging to the same subscriber. It is unique to this subscriber so that two subscribers cannot have the same key K_{AB}. The subscription key can be loaded into a new security module acquired by a subscriber already disposing of a decoder and of a security module. This loading can be carried out, for example, by means of a vocal server, to which the subscriber indicates his subscription number as well as the unique identification number UA of the security module acquired. A key can be transmitted in a secure message, this key can be identical to a key present in the security modules acquired previously, or can be a new key that can be sent to all the security modules of the subscriber. The subscription key can be loaded at the same time as the rights for a determined event are loaded. For this, it is possible to send only one authorization message EMM containing the subscription key K_{AB} and the rights. This is possible as long as the bandwidth available is sufficient. It is also possible to send the subscription key K_{AB} in an authorization message EMM independent of the rights. This allows the minimization of the bandwidth necessary. The subscription key K_{AB} is then stored for further use in all the security modules of the subscriber.

The authorization message EMM generated by the management centre for a determined subscriber contains an identifier common to all the decoders of the subscriber, this identifier being able, for example, to be the subscription number or an identifier which derives from said number. It also contains the rights that are encrypted by means of the key K_{AB} common to all the security modules of the subscriber. In this way, only one message can be sent and used by an entire decoder group belonging to the same subscriber. This message is then received by the decoders that filter the authorization messages EMM according to the identifier of the security modules to which they are associated. When the messages are received by the decoders in question and are filtered by the latter, they are then processed in a conventional way by each of the decoders and the associated security modules in order to extract the rights.

The process according to the invention is particularly interesting due to the fact that it simplifies the management of messages for subscribers with several decoders.

1. Method to update access right to conditional access data, the method comprising:
determining a group number in which access rights must be updated;
determining all security modules related to this group number;
determining encrypting keys of the security modules;
encrypting the access rights with the encrypting keys;
sending authorization messages containing said encrypted access rights and an identifier of the security modules for which they are intended; and
receiving and decrypting the access rights in the security modules corresponding to said identifiers.

2. Method to update access right according to claim 1, wherein the determining of the security modules connected to a group number includes searching in a database, for the unique identification numbers associated to this group.

3. Method to update access right to conditional access data, comprising:
determining a group number in which access rights must be updated;
determining all the security modules connected to the group number;
determining a subscription key common to all the security modules connected to the group number;
encrypting the access rights with the subscription key;
sending an authorization message containing the encrypted rights and an identifier of the security modules for which they are intended;
receiving and decrypting the access rights in the security modules corresponding to the identifier.

4. Method to update access right according to claim 1, wherein the method is for a Pay-TV system including an access rights management centre, the management centre transmitting the rights to decoders associated with the security modules.

5. Method to update access right according to claim 3, wherein the method is for a Pay-TV system including an access rights management centre, the management centre transmitting the rights to decoders associated with the security modules.

6. Method to update access right according to claim 1, wherein the method is for Pay-TV, wherein the rights are transmitted to decoders associated with the security modules.

7. Method to update access right according to claim 1, wherein the method is for Pay-TV, wherein the rights are transmitted to decoders associated with the security modules.
